(19) United States
(12) Patent Application Publication
(10) Pub. No.: US 2015/0331975 A1
(43) Pub. Date: Nov. 19, 2015

(54) A METHOD FOR ANALYZING FLIGHT DATA RECORDED BY AN AIRCRAFT IN ORDER TO CUT THEM UP INTO FLIGHT PHASES

(71) Applicant: SAGEM DEFENSE SECURITE, Boulogne-Billancourt (FR)

(72) Inventors: Edouard Garnier de Labareyre, Boulogne-Billancourt (FR); Victor Lefebvre, Boulogne-Billancourt (FR)

(21) Appl. No.: 14/389,958

(22) PCT Filed: Apr. 4, 2013
(86) PCT No.: PCT/EP2013/057102

§ 371 Date: Oct. 1, 2014

(30) Foreign Application Priority Data
Apr. 4, 2012 (FR) 1253082

(51) Int. Cl. G06F 17/50

(52) U.S. Cl. CPC G06F 17/5009

(57) ABSTRACT

The invention relates to a method for analyzing flight data recorded during at least one flight of an aircraft, the flight data comprising data relating to characteristic parameters of the flight, the method comprising a step for determining a state model of a flight comprising several states, each state corresponding to a possible flight phase of the aircraft, the state model comprising transitions defining the switchings between these so-called states and at least one criterion for initializing the state model, said initialization criterion corresponding to an initial state of the state model, each transition and each initialization criterion depending on at least one characteristic parameter which may be recorded during the flight of the aircraft.

### GENERAL TECHNICAL FIELD

The invention relates to the analysis of a set of flight data recorded during at least one flight of an aircraft.

### STATE OF THE ART

Regulations in terms of maintenance and air traffic define standards with which airline companies have to comply in order to ensure a maximum level of safety for a user.

In order to optimize and monitor air operations, the companies under pressure from supervisory authorities, have equipped themselves with systems for analyzing flight data.

Systems for analyzing flight data are known under the name of FDM (Flight Data Monitoring) or else FPQA (Flight Operational Quality Assurance). These systems consist of equipping an aircraft with a flight data recorder. Such a recorder is for example a black box or else a specific recorder such as an ACMS (Aircraft Conditioning Monitoring System).

With these systems, airline companies are able to understand in detail the course of a flight from regular recordings of the values of these flight data, carried out during each flight of each of their airplanes.

To do this, these systems detect predefined events having occurred during the flight and an expert then analyzes these events which indicate that a technical incident occurred during the flight, that a practice or a condition foreseen by a flight procedure was not observed, thus issuing a warning at a very early stage of possible incidents or accidents which may occur.

In order to apply this detection, the recorded data have to be cut up per flight and each flight has to be cut up into flight phases.

Indeed, the detection of an event is conditioned by the current flight phase. For example, the same types of events will not be expected during take-off of the aircraft as upon cruising.

Thus, the quality of the cutting-up of the recorded data and of the cutting-up method allows the relevance of the analysis to be guaranteed.

Methods for analyzing flight data consisting of cutting up recorded flight data are known.

These known methods are based on the setting up of decision criteria as to the value of certain flight parameters. They are also based on typical theoretical sequences of events.

Finally, the criteria use single source parameters.

A problem is that the criteria used are not robust to recording faults (discontinuity or values out of the perimeter), to the diversity of the airplane types, to the diversity of flight operations or to the unknown factors of air operations generating marginal situations.

### Presentation of the Invention

The invention proposes to overcome at least one of these drawbacks.

For this purpose, the invention proposes a method for analyzing flight data recorded during at least one flight of an aircraft, the flight data comprising data relating to characteristic parameters of the flight, the method comprising a step for determining a model of states of a flight comprising several states, each state corresponding to a possible flight phase of the aircraft, the state model comprising transitions defining the changes among these so-called states and at least one criterion for initializing the state model, said initialization criterion corresponding to an initial state of the state model, each transition and each initialization criterion depending on at least one characteristic parameter which may be recorded during the flight of the aircraft.

The method according to the invention further comprises successively the following steps:
extracting the recorded flight data, flight data relating to characteristic parameters of the aircraft;
calculating an initialization criterion from flight data relating to the characteristic parameters of the aircraft in order to detect an initial instant from which the flight data correspond to an initial state of the state model;
calculating a plurality of transitions of the state model from flight data relating to characteristic parameters recorded after the initial instant in order to detect instants from which the flight data relating to characteristic parameters of the aircraft correspond to a change of state of the state model;
cutting up the flight data according to the thereby determined instants in order to match the recorded flight data with flight phases.

The invention is advantageously completed by the following characteristics, taken alone or in any of their technically possible combination;
the calculation of the transitions comprises after detection of the initial state, at least one calculation of a transition of the state model giving the possibility of passing from the initial state to a state, a so-called current state, corresponding to a flight phase.
the calculation of the transitions comprises at least one calculation of a transition giving the possibility of passing from the current state to a state posterior to said current state.
a time interval between two transitions is determined, in order to determine the period of time during which the flight data correspond to a state of the state model.
the initial state of the state model is the cruising aircraft or the aircraft at the end of the flight.
the calculation of a transition consists of calculating a decision criterion depending on flight data relating to at least one characteristic parameter of the aircraft.
the flight data before the instant from which the flight data correspond to an initial state are suppressed.
the characteristic parameters are: vertical acceleration, horizontal acceleration, longitudinal acceleration, pitch, configuration of the flaps, vertical speed and horizontal speed, barometric altitude, radio altitude, state of the landing gear, the heading.
the states of the state model are: end of the flight, engine start, taxi out, take off, rejected take off, second segment, initial climb, climb, descent, cruise, approach, go around, final approach, landing, touch and go, taxi in.

The invention also relates to a system for analyzing flight data, comprising a processing unit adapted for applying the method according to one of the preceding claims, and a storage unit for storing the state model.

The advantages of the invention are multiple.

The cutting-up of the recorded data is automatic while a manual cutting-up of the flights and of the phases would take at least five minutes per flight.

The cutting-up is robust to recording faults.

The criteria used are independent of the type of airplane since the parameters used are generic parameters recorded on all aircraft.

The accuracy in the cutting-up is further increased.

### PRESENTATION OF THE FIGURES

Other characteristics, objects and advantages of the invention will become apparent from the following description, which is purely an illustration and not a limitation, and which should be read with reference to the appended drawings wherein:

FIG. 1 illustrates the steps of a method according to an embodiment of the invention;

FIG. 2 illustrates a state model according to an embodiment of the invention;

FIG. 3 illustrates an example for determining a transition according to an embodiment of the invention.

### DETAILED DESCRIPTION OF THE INVENTION

As mentioned in the introduction, flight data are recorded during at least one flight of an aircraft.

These flight data correspond to parameters of the aircraft, which are recorded. These may be the speed, the altitude, the position of the flaps, etc.

These recorded data are recovered in the form of a matrix, each line of which corresponds to recordings of the aircraft parameters during a flight.

In order to associate the flight data with flight phases, the flight data recorded per flight phase are suitably cut up.

Once they are cut up, they may be analyzed in a relevant way.

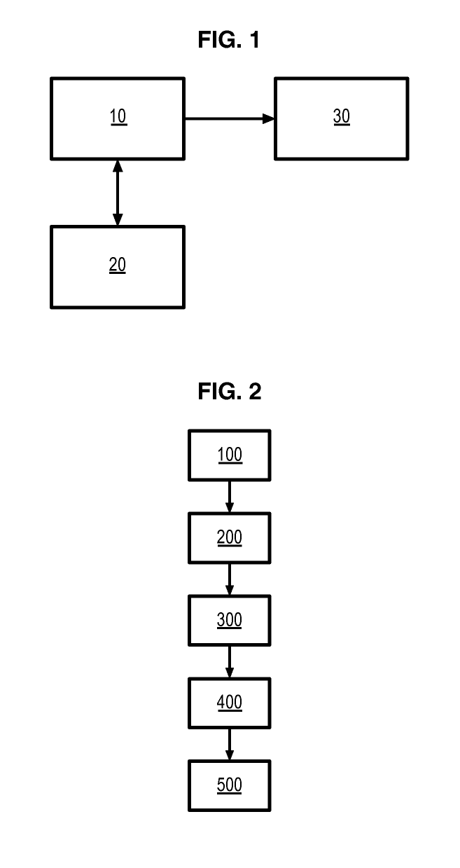

FIG. 1 illustrates a system for analyzing flight data according to an embodiment of the invention. Such a system comprises a storage unit 10, a processing unit 20 comprising a processor (not shown), a display unit 30.

The storage unit 10 comprises a memory (not shown) for storing flight data stemming from recordings during several flights of an aircraft. Such a storage unit 10 may be formed by a hard disc or an SSD, or any other removable and rewritable storage means (USB sticks, memory cards, etc).

The processing unit 20 allows application of a method for analyzing flight data (see hereafter). The storage unit 10 may be a ROM/RAM memory of the processing unit 20, a USB stick, a memory card. Such a processing unit is for example computer(s), processor(s), microcontroller(s), microcomputer(s), programmable logic controller(s), specific application integrated circuit(s), other programmable circuit(s) or other devices which include a computer, such as a work station.

The display unit 30 allows the result of the method to be displayed, notably cut-up flight data. Such a display unit may for example be a computer screen, a monitor, a flat screen, a plasma screen or any other type of display device of a known type.

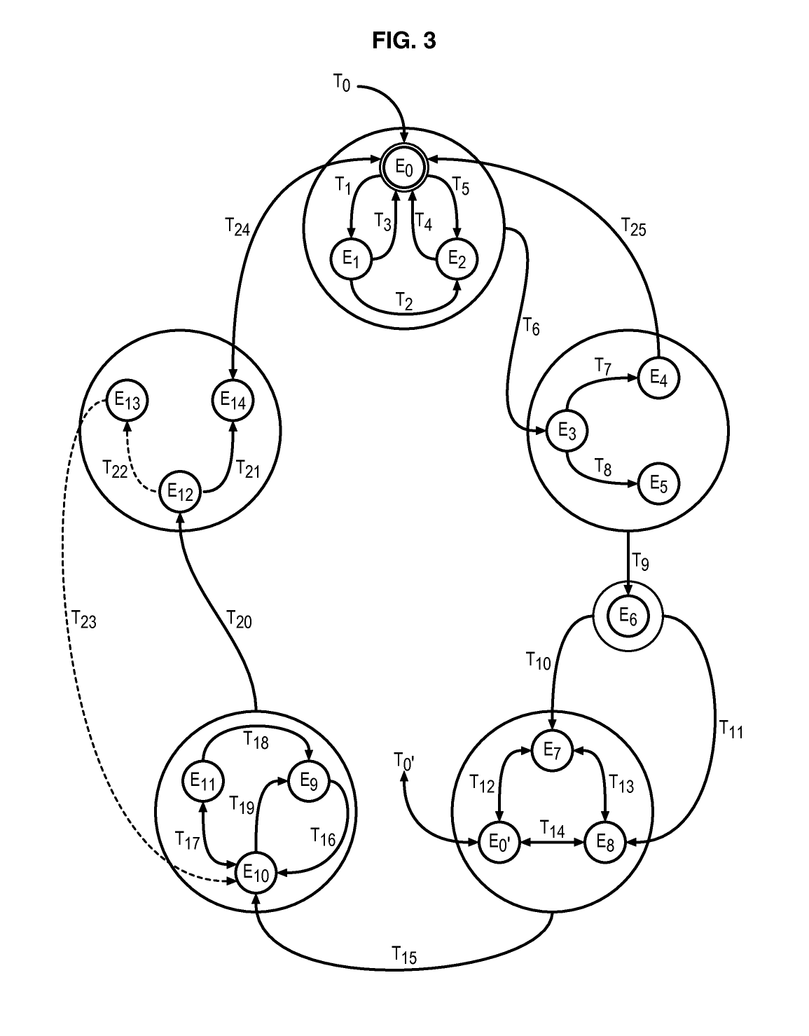

In connection with FIG. 2, a method for analyzing flight data is described.

In a first step 100, a state model (or a state machine) of a flight is determined. Such a determination may be the loading of the state model into the storage unit 10 of the analysis system.

FIG. 3 illustrates such a state model. This state model is notably stored in the storage unit 10 of the system for analyzing flight data of FIG. 1.

Such a state model comprises several states E0, E0′, E1, E2, E3, E4, E5, E6, E7, E8, E9, E10, E11, E12, E13, E14, E15, E16.

Each state corresponds to a possible flight phase in which the aircraft may be during a flight.

These flight phases are: end of flight E0, engine start E1, taxi out E2, take off E3, rejected take off E4, second segment E5, initial climb E6, climb E7, descent E8, cruise E0′, approach E10, go around E9, final approach E11, landing E12, touch and go E14, taxi in E15.

For explanations relating to the different flight phases, reference may be made to the document: Commercial Aviation Safety Team, International Civil Aviation Organization, “phase of flight definitions and usage notes”, June 2010.

The state model comprises transitions, T1, T2, T3, T4, T5, T6, T7, T8, T9, T10, T11, T12, T13, T14, T15, T16, T17, T18, T19, T20, T21, T22, T23, T24 defining switchings between different states.

The state model also comprises two initialization criteria T0, T0′ corresponding to an initial state E0, E0′ of the state model.

Both of these initialization criteria T0, T0′ are two input possibilities in the state model.

Each transition and each initialization criterion depends on at least one characteristic parameter which may be recorded during the flight of the aircraft.

The characteristic parameters are preferably parameters which are conventionally recorded in most aircraft.

These parameters are (the usual terminology used in aeronautics): turbine rotation speed (N2), engine fuel flow 1, engine fuel flow 2, exhaust gas temperature (EGT), vertical acceleration, longitudinal acceleration, pitch, position of the landing gear, heading, speed relatively to the ground, configuration of the flaps, vertical speed, Mach number, barometric altitude, radio altitude.

Within the scope of the analysis method, in a second step 200, flight data relating to characteristic parameters of the aircraft are extracted from the recorded flight data. These parameters are listed above.

For proceeding with the cutting up of the flight data, in a step 300, an initialization criterion is calculated. In particular, the recording instant at which the flight data correspond to an initial state of the aircraft, will be detected. The initial state of the state model is “the aircraft is cruising” E0′ or “the aircraft is at the end of flight” E0.

This step 300 for example allows suppression of the flight data which may be relative to an incomplete flight, i.e. by suppressing the flight data before the instant from which the flight data correspond to an initial state.

Alternatively, these data may also be analyzed but for other purposes since flight phases cannot be associated with them.

Next, in step 400, several transitions of the state model will be calculated from flight data relating to characteristic parameters recorded after the initial instant in order to detect the instant from which the flight data relating to characteristic parameters of the aircraft correspond to a change of state of the state model.

In other words, once the initial state is detected, one of the possible transitions from this detected initial state will be detected. This phase for calculating transitions will then be repeated so as to process the whole available recording duration.

It is noted that the calculation of the transitions consists of calculating a decision criterion depending on flight data relating to at least one characteristic parameter of the aircraft.

As an example, as illustrated in FIG. 3, if starting from the state E0, a transition T5 is detected, the conclusion may be drawn that the aircraft is in the state E2.

Therefore by detecting a transition, a time interval may be inferred, during which the flight data correspond to a state of the state model.

Therefore it is from the transition detections that the conclusion may be drawn that there is a change of state.

By using a state model, it is possible to avoid an exhaustive search. Indeed, starting from one state, a limited number of transitions is to be detected.

After detection of the transitions, in a step 500, the flight data are cut up according to the thereby determined instants in order to have the recorded flight data correspond to flight phases.

The method is executed at each second of the recording. However, certain parameters are required at higher frequencies, thus iteration of the algorithm may use values of parameters at instants located outside the execution step of the process (1 Hz).

As already mentioned, the transitions depend on at least one characteristic parameter of the aircraft.

A transition may depend on a single characteristic parameter. In this case, the transition is calculated from flight data relating to this characteristic parameter and the latter transition is compared with a threshold, for example in order to decide whether the transition is detected.

A transition may depend on several characteristic parameters. In this case, the flight data relating to these characteristic parameters are processed, they are combined and the result is compared with a threshold for example in order to decide whether the transition is detected.

As an example for calculating the take off condition, four parameters will be used: the engine fuel flow 1 in order to detect that the engine 1 is gathering momentum, the engine fuel flow 2 in order to detect that the engine 2 is gathering momentum, the velocity relatively to the ground in order to detect that the aircraft is moving, and the longitudinal acceleration in order to detect that the aircraft is in an acceleration phase.

The calculation of the transition is carried out while first checking several parameters and associating a weight to each check.

The checked parameters are the following:
the engine 1 is gathering momentum if the parameter relating to the engine fuel flow 1 is equal to a certain value for at least 3 seconds;
the engine 2 is gathering momentum if the parameter relating to the engine fuel flow 1 is equal to a certain value for at least 3 seconds;
the aircraft is moving if the velocity relatively to the ground is greater than 5 knots;
the aircraft is accelerating if the longitudinal acceleration is greater than 0.1 g.

For each check whether the condition is met, a value 1 is associated, if it is not met, a zero value is associated.

The transition will be detected if by summing up the four conditions, a value of at least 3 is obtained (three conditions out of four are met) in order to detect that the aircraft is taking off.

1. A method for analyzing flight data recorded during at least one flight of an aircraft, the flight data comprising data relating to characteristic parameters of the flight, the method comprising a step for:
determining (10) a state model of a flight comprising several states (E0-E16, E0′), each state corresponding to a possible flight phase of the aircraft, the state model comprising transitions (T1-T19) defining switchings between these so-called states and at least one criterion (T0-T0′) for initialization of the state model, said initialization criterion (T0, T0′) corresponding to an initial state (E0, E0′) of the state model, each transition and each initialization criterion depending on at least one characteristic parameter which may be recorded during the flight of the aircraft;
the method further successively comprising the following steps:
extracting (20) from recorded flight data, flight data relating to characteristic parameters of the aircraft;
calculating (30) an initialization criterion from flight data relating to the characteristic parameters of the aircraft in order to detect an initial instant from which the flight data correspond to an initial state of the state model;
calculating (40) a plurality of transitions of the state model from flight data relating to characteristic parameters recorded before the initial instant in order to detect instants from which the flight data relating to characteristic parameters of the aircraft correspond to a change of state of the state model;
cutting up (50) the flight data depending on the thereby determined instants in order to match the recorded flight data with flight phases.

2. The method according to claim 1, wherein the calculation of the transitions comprises after detection of the initial state, at least one calculation of a transition of the state model giving the possibility of passing from the initial state to a state,
a so-called current state, corresponding to a flight phase.

3. The method according to claim 2, wherein the calculation of the transitions comprises at least one calculation of a transition giving the possibility of passing from the current state to a state posterior to said current state.

4. The method according to claim 1, wherein the time interval between two transitions is determined in order to determine the duration during which the flight data correspond to a state of the state model.

5. The method according to claim 1, wherein the initial state of the state model is the cruising aircraft or the aircraft at the end of the flight.

6. The method according to claim 1, wherein the calculation of a transition consists of calculating a decision criterion depending on flight data, relating to at least one characteristic parameter of the aircraft.

7. The method according to claim 1, wherein the flight data before the instant from which the flight data correspond to an initial state, are suppressed.

8. The method according to claim 1, wherein the characteristic parameters are: vertical acceleration, horizontal acceleration, longitudinal acceleration, horizontal acceleration, longitudinal acceleration, pitch, configuration of the flaps, vertical speed and horizontal speed, barometric altitude, radio altitude, condition of the landing gear, heading.

9. The method according to claim 1, wherein the states of the state model are: end of flight, engine start, taxi out, take off, rejected take off, second segment, initial climb, climb, descent, cruise, approach, go around, final approach, landing, touch and go, taxi in.

10. A system for analyzing flight data, comprising a processing unit adapted for applying a method according to claim 1 and a storage unit for storing the state model.
